(19) United States
(12) Patent Application Publication
(10) Pub. No.: US 2017/0003313 A1
(43) Pub. Date: Jan. 5, 2017

(54) SENSOR

(71) Applicant: KABUSHIKI KAISHA TOSHIBA, Tokyo (JP)

(72) Inventors: Takahiro OMORI, Kawasaki (JP); Kazuo WATABE, Yokohama (JP); Osamu NISHIMURA, Kawasaki (JP); Akihiro KASAHARA, Sanbu (JP)

(21) Appl. No.: 15/196,897

(22) Filed: Jun. 29, 2016

(30) Foreign Application Priority Data
Jun. 30, 2015 (JP) 2015-131631

(51) Int. Cl. G01P 15/125

(52) U.S. Cl. CPC G01P 15/125

(57) ABSTRACT

According to one embodiment, a sensor includes a structure body, a first flexible unit, and a first sensing unit. The structure body includes a first portion and a second portion. The second portion is linked to the first portion. The first portion is displaced along a first direction intersecting a direction connecting the first portion and the second portion. The second portion is displaced along a second direction according to the displacement of the first portion. The second direction intersects the first direction. The first flexible unit deforms along the second direction according to the displacement of the second portion along the second direction. The first sensing unit senses the deformation of the first flexible unit.

### CROSS-REFERENCE TO RELATED APPLICATIONS

This application is based upon and claims the benefit of priority from Japanese Patent Application No. 2015-131631, filed on Jun. 30, 2015; the entire contents of which are incorporated herein by reference.

### FIELD

Embodiments described herein relate generally to a sensor.

### BACKGROUND

For example, there is a sensor that includes a MEMS (Micro Electro Mechanical System). It is desirable to increase the sensitivity of the sensor. For example, applications of the sensor are increased by increasing the sensitivity in the low frequency range (about 0.1 Hz to 10 Hz).

### BRIEF DESCRIPTION OF THE DRAWINGS

FIG. 1A to FIG. 1C are schematic cross-sectional views illustrating a sensor according to a first embodiment;

FIG. 2 is a schematic cross-sectional view illustrating another sensor according to the first embodiment;

FIG. 3 is a schematic cross-sectional view illustrating a portion of another sensor according to the first embodiment;

FIG. 4A and FIG. 4B are schematic cross-sectional views illustrating another sensor according to the first embodiment;

FIG. 5A and FIG. 5B are schematic cross-sectional views illustrating another sensor according to the first embodiment;

FIG. 6 is a schematic cross-sectional view illustrating another sensor according to the first embodiment;

FIG. 7 is a schematic cross-sectional view illustrating another sensor according to the first embodiment;

FIG. 8 is a schematic cross-sectional view illustrating another sensor according to the first embodiment;

FIG. 9A to FIG. 9C are schematic cross-sectional views illustrating another sensor according to a second embodiment;

FIG. 10 is a schematic cross-sectional view illustrating another sensor according to the second embodiment;

FIG. 11 is a schematic cross-sectional view illustrating another sensor according to a third embodiment; and

FIG. 12 is a schematic cross-sectional view illustrating the sensor according to the embodiment.

### DETAILED DESCRIPTION

According to one embodiment, a sensor includes a structure body, a first flexible unit, and a first sensing unit. The structure body includes a first portion and a second portion. The second portion is linked to the first portion. The first portion is displaced along a first direction intersecting a direction connecting the first portion and the second portion. The second portion is displaced along a second direction according to the displacement of the first portion. The second direction intersects the first direction. The first flexible unit deforms along the second direction according to the displacement of the second portion along the second direction. The first sensing unit senses the deformation of the first flexible unit.

Various embodiments will be described hereinafter with reference to the accompanying drawings.

### First Embodiment

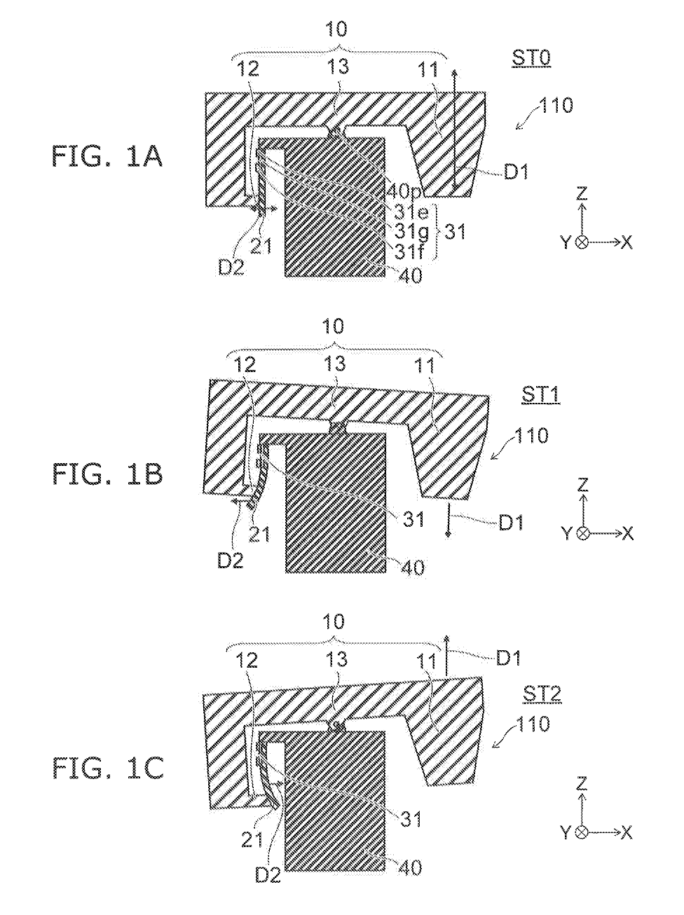

FIG. 1A to FIG. 1C are schematic cross-sectional views illustrating a sensor according to a first embodiment.

FIG. 1A illustrates one state ST0 (e.g., the initial state). FIG. 1B illustrates a first state ST1. FIG. 1C illustrates a second state ST2.

As shown in FIG. 1A, the sensor 110 according to the embodiment includes a structure body 10, a first flexible unit 21, and a first sensing unit 31. In the example, the sensor 110 further includes a supporter 40.

The structure body 10 includes a first portion 11, a second portion 12, and a third portion 13. The second portion 12 is linked to the first portion 11, in the example, the third portion 13 is provided between the first portion 11 and the second portion 12.

The first portion 11 is displaced along a first direction D1. In the example, the first direction D1 substantially corresponds to a Z-axis direction. One direction perpendicular to the Z-axis direction is taken as an X-axis direction. A direction perpendicular to the Z-axis direction and the X-axis direction is taken as a Y-axis direction.

The first direction D1 intersects the direction connecting the first portion 11 and the second portion 12. In the state ST0 shown in FIG. 1A, the direction connecting the first portion 11 and the second portion 12 is substantially aligned with the X-axis direction.

In the example, the supporter 40 supports the third portion 13 of the structure body 10. For example, a pin 40p is provided to pierce the third portion 13 and a portion of the supporter 40. The structure body 10 is rotatable with the pin 40p as a center. The first portion 11 is displaced along the first direction D1 according to the rotation. The structure body 10 is, for example, a lever. The pin 40p corresponds to a fulcrums

The second portion 12 is displaced along a second direction D2 according to the displacement of the first portion 11. The second direction D2 intersects the first direction D1. The second direction D2 is non-parallel to the first direction D1. Due to the rotation of the structure body 10 recited above, the first portion 11 is displaced along the first direction D1; and the second portion 12 is displaced along the second direction D2 in conjunction with the displacement of the first portion 11.

For example, FIG. 1B illustrates one state (the first state ST1) of the displacement. FIG. 1C illustrates one other state (the second state ST2) of the displacement. In the first state ST1 as shown in FIG. 1B, for example, the first portion 11 is displaced toward the downward direction in the drawing along the first direction D1. The second portion 12 is displaced toward the left direction in the drawing along the second direction D2 in conjunction with the displacement of the first portion 11. In the second state ST2 as shown in FIG. 1C, for example, the first portion 11 is displaced toward the upward direction in the drawing along the first direction D1. The second portion 12 is displaced toward the right direction in the drawing along the second direction D2 in conjunction with the displacement of the first portion 11.

The first flexible unit 21 deforms along the second direction D2 according to the displacement along the second direction D2 of the second portion 12 recited above. The second portion 12 pushes the first flexible unit 21 along the second direction D2. The second portion 12 pulls the first flexible unit 21 along the second direction D2. The first flexible unit 21 includes, for example, a thin film. For example, the first flexible unit 21 may include a silicon thin film. The thickness (the length along the second direction D2) of the first flexible unit 21 is, for example, not less than 0.01 μm (micrometers) and not more than 1000 μm. Thereby, appropriate flexibility is obtained.

The first sensing unit 31 senses the deformation along the second direction D2 of the first flexible unit 21.

In the example, the first sensing unit 31 includes a first element unit 31g, a first electrode 31e, and a second electrode 31f. Stress is applied to the first element unit 31g according to the deformation of the first flexible unit 21. The first element unit 31g deforms according to the deformation of the first flexible unit 21. The first element unit 31g is, for example, a silicon thin film. The first element unit 31g may be continuous with the first flexible unit 21. The first electrode 31e is connected to the first element unit 31g. The second electrode 31f is connected to the first element unit 31g and is separated from the first electrode 31e.

An electrical characteristic (e.g., the electrical resistance) between the first electrode 31e and the second electrode 31f changes according to the deformation of the first flexible unit 21. For example, in the case where the first element unit 31g is silicon, when the first element unit 31g deforms according to the deformation of the first flexible unit 21, the electrical resistance of the first element unit 31g (the electrical characteristic between the first electrode 31e and the second electrode 31f) changes. In the case where, for example, a piezoelectric body is used as the first element unit 31g, when the first element unit 31g deforms according to the deformation of the first flexible unit 21, the potential difference that is generated in the first element unit 31g (the potential difference between the first electrode 31e and the second electrode 31f) changes. As described below, the first sensing unit 31 may sense an electrostatic capacitance according to the deformation along the second direction D2 of the first flexible unit 21. In the embodiment, the method (and structure) for sensing the deformation along the second direction D2 of the first flexible unit 21 is arbitrary.

In the sensor 110 according to the embodiment, the first portion 11 is displaced along the first direction D1; and the second portion 12 is displaced along the second direction D2 according to the displacement of the first portion 11. The first flexible unit 21 deforms along the second direction D2 according to the displacement along the second direction D2 of the second portion 12. Such a deformation along the second direction D2 of the first flexible unit 21 is sensed by the first sensing unit 31. Thereby, for example, the acceleration that is applied to the sensor 110 can be sensed with high sensitivity.

In other words, the first portion 11 is, for example, a weight. The first portion 11 is displaced along the first direction D1 due to the acceleration applied to the sensor 110. The first flexible unit 21 is displaced along the second direction D2 that is different from the first direction D1 via the displacement of the second portion 12 in conjunction with the first portion 11. The deformation of the first flexible unit 21 is not easily affected by forces along the first direction D1 due to the mass of the first flexible unit 21. The effect of the mass of the first flexible unit 21 (its own weight) is suppressed. Thereby, the displacement along the first direction D1 of the first portion 11 can be sensed with high sensitivity. In other words, the acceleration along the first direction D1 of the first portion 11 can be sensed with high sensitivity.

For example, in a reference example, a weight that is displaced in the same direction as the displacement direction of the first flexible unit is combined with the first flexible unit. In the reference example, when a force (an acceleration) is applied to the weight, the weight is displaced along the first direction; and the first flexible unit also is displaced along the first direction according to the displacement. The displacement in the first direction of the first flexible unit is affected by the mass of the first flexible unit itself.

In the embodiment, the direction (the first direction D1) of the displacement of the first portion 11 (e.g., the weight) intersects the direction (the second direction D2) of the deformation of the first flexible unit 21. Therefore, even when an acceleration along the first direction D1 is applied to the first flexible unit 21, the effects of the acceleration on the first flexible unit 21 can be suppressed. Thereby, the sensitivity can be increased.

The first portion 11 functions as a weight. The mass of the first portion 11 is larger than the mass of the first flexible unit 21. The mass of the first portion 11 is, for example, not less than 10 times the mass of the first flexible unit 21. The mass of the first portion 11 is not more than 100 times the mass of the first flexible unit 21.

For example, the mass of the first portion 11 is not less than 1 times and not more than 10⁶ times the flexural rigidity of the first flexible unit 21.

For example, in the embodiment, the sensor 110 has a peak sensitivity frequency. The sensitivity of the sensor 110 is a maximum at the peak sensitivity frequency. In the embodiment, the peak sensitivity frequency is, for example, 10 Hz or less. Thereby, for example, high sensitivity is obtained at low frequencies. In the embodiment, the peak sensitivity frequency is, for example, 0.1 Hz or more. The peak sensitivity frequency of the acceleration sensed by the first sensing unit 31 is not less than 0.1 Hz and not more than 10 Hz. The peak sensitivity frequency of the displacement sensed by the first sensing unit 31 is not less than 0.1 Hz and not more than 10 Hz.

In the embodiment, the structure body 10 includes, for example, alumina, silicon, iron, stainless steel, etc. The distance between the first portion 11 and the second portion 12 is, for example, not less than about 0.01 mm and not more than about 10 mm. The mass of the first portion 11 is, for example, not less than 0.1 g and not more than 10 g.

The first flexible unit 21 includes, for example, monocrystalline silicon, polycrystalline silicon, etc. The thickness of the first flexible unit 21 is not less than 0.01 mm and not more than 10 mm. The mass of the first flexible unit 21 is, for example, not less than 0.1 μg and not more than 10 g.

In the embodiment, the materials, configurations, and sizes recited above relating to the structure body 10 and the first flexible unit 21 are described as examples and are arbitrary in the embodiment.

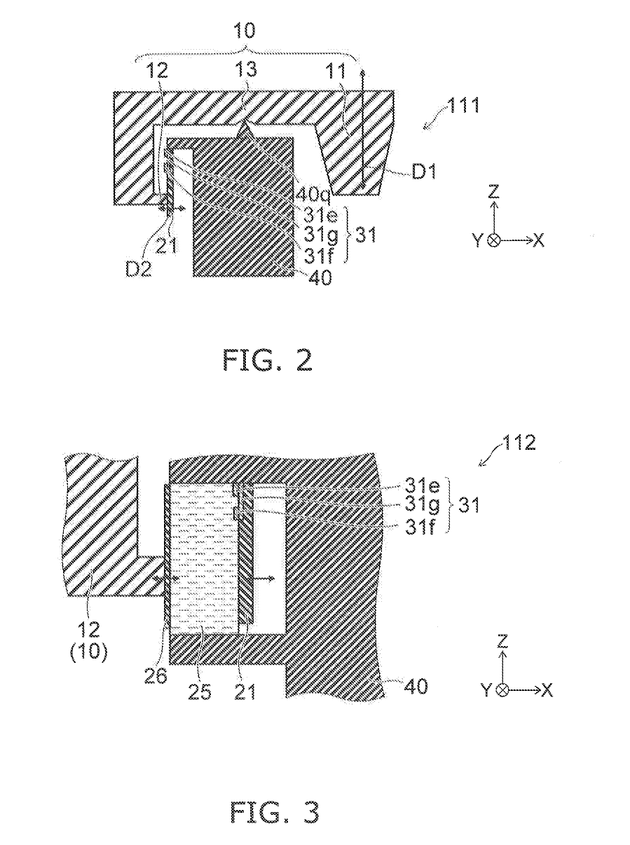

FIG. 2 is a schematic cross-sectional view illustrating another sensor according to the first embodiment.

In the sensor 111 according to the embodiment as shown in FIG. 2, a protrusion 40q is provided in the supporter 40. The third portion 13 of the structure body 10 is supported by the protrusion 40q. Otherwise, the sensor 111 is similar to the sensor 110. For the sensor 111 as well, the sensitivity can be increased.

FIG. 3 is a schematic cross-sectional view illustrating a portion of another sensor according to the first embodiment.

FIG. 3 shows an enlarged portion including the second portion 12 of the structure body 10, the first flexible unit 21, and a portion of the supporter 40.

As shown in FIG. 3, the sensor 112 according to the embodiment further includes an intermediate layer 25. The intermediate layer 25 is provided between the first flexible unit 21 and the second portion 12 of the structure body 10. The intermediate layer 25 includes a flexible medium. For example, the Young's modulus of the intermediate layer 25 is lower than the Young's modulus of the first flexible unit 21. For example, the Young's modulus of the intermediate layer 25 is not less than about 0.01 MPa and not more than about 1 MPa.

The intermediate layer 25 includes, for example, a liquid. The liquid includes, for example, a silicone oil, a machine oil, etc. It is desirable for the liquid to be nonvolatile (to have low volatility). High storageability and high environmental resistance are obtained. The intermediate layer 25 may include, for example, a polymer. The polymer includes, for example, natural rubber, synthetic rubber, an epoxy resin, etc. The polymer may include, for example, crosslinked PDMS (polydimethylsiloxane). The intermediate layer 25 may include an elastic body.

In the example, a linking unit 26 is provided between the second portion 12 and the intermediate layer 25. The linking unit 26 includes, for example, a metal, etc. The linking unit 26 is linked to the second portion 12. In the case where the intermediate layer 25 includes a liquid, the outflow of the liquid is suppressed by the linking unit 26. For example, the liquid is held in the space defined by the first flexible unit 21 and the linking unit 26 by the surface tension of the liquid.

The displacement in the second direction D2 of the second portion 12 is transferred to the first flexible unit 21 via the intermediate layer 25. The force due to the displacement of the second portion 12 according to the displacement of the first portion 11 is relaxed by the intermediate layer 25 and transferred by the intermediate layer 25 to the first flexible unit 21. For example, failure of the first flexible unit 21 is suppressed.

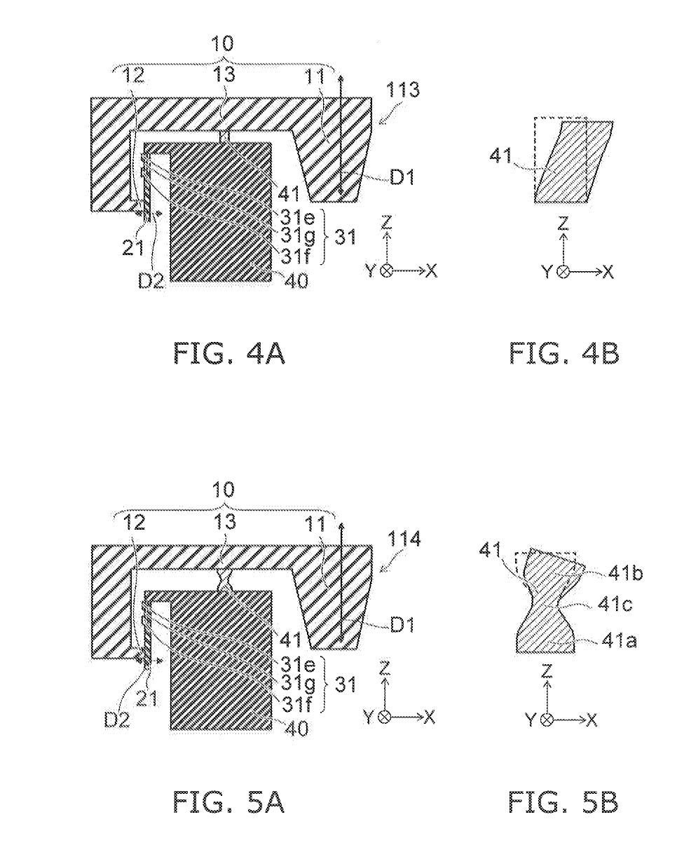

FIG. 4A and FIG. 4B are schematic cross-sectional views illustrating another sensor according to the first embodiment.

FIG. 4A shows the sensor 113 according to the embodiment. FIG. 4B shows a portion of the sensor 113.

As shown in FIG. 4A, the sensor 113 according to the embodiment further includes a first elastic unit 41 in addition to the structure body 10, the first flexible unit 21, the first sensing unit 31, and the supporter 40. The structure body 10 includes the third portion 13 between the first portion 11 and the second portion 12. The first elastic unit 41 is provided between the supporter 40 and the third portion 13. The supporter 40 supports the third portion 13 via the first elastic unit 41. Otherwise, the sensor 113 is similar to the sensor 110; and a description is omitted.

FIG. 4B illustrates the first elastic unit 41. The first elastic unit 41 is deformable. The first elastic unit 41 deforms in a direction intersecting the Z-axis direction (the first direction D1). The first elastic unit 41 receives the force of the displacement of the first portion 11 of the structure body 10. The first elastic unit 41 relaxes the force by the deformation of the first elastic unit 41. By using the first elastic unit 41, for example, failure of at least one of the structure body 10 or the first flexible unit 21 is suppressed.

The first elastic unit 41 is, for example, a parallel spring. The first elastic unit 41 includes, for example, at least one of iron, aluminum, stainless steel, silicon, or alumina.

FIG. 5A and FIG. 58 are schematic cross-sectional views illustrating another sensor according to the first embodiment.

FIG. 5A shows the sensor 114 according to the embodiment. The first elastic unit 41 is provided in the example as well. FIG. 5B shows a portion (the first elastic unit 41) of the sensor 114.

In the sensor 114 as shown in FIG. 5A and FIG. 5B, the first elastic unit 41 is, for example, an elastic hinge. A first region 41a, a second region 41b, and a third region 41c are provided in the first elastic unit 41. The second region 41b is provided between the first region 41a and the structure body 10. The third region 41c is provided between the first region 41a and the second region 41b. The width in the X-axis direction (e.g., a direction perpendicular to the first direction D1) of the third region 41c is narrower than the width in the X-axis direction of the first region 41a and narrower than the width in the X-axis direction of the second region 41b. The first elastic unit 41 deforms easily.

The first elastic unit 41 is deformable in the example as well. The first elastic unit 41 deforms in a direction intersecting the Z-axis direction (the first direction D1). By using the first elastic unit 41, for example, the failure of at least one of the structure body 10 or the first flexible unit 21 is suppressed.

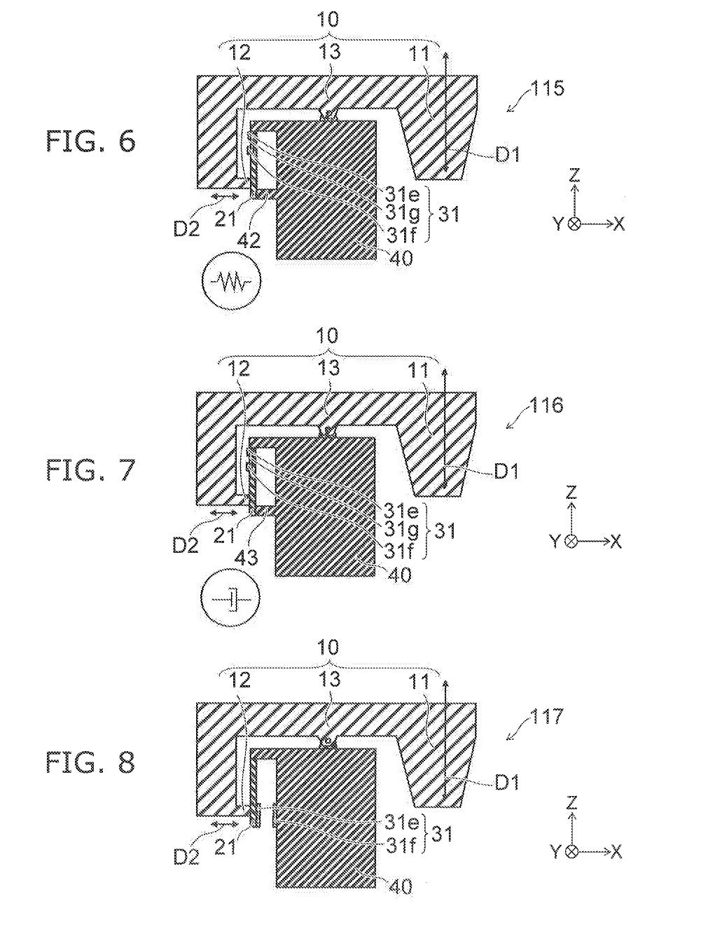

FIG. 6 is a schematic cross-sectional view illustrating another sensor according to the first embodiment.

As shown in FIG. 6, the sensor 115 according to the embodiment further includes a second elastic unit 42 in addition to the structure body 10, the first flexible unit 21, the first sensing unit 31, and the supporter 40. The second elastic unit 42 is connected to the supporter 40 and the second portion 12. The second elastic unit 42 is, for example, a spring. Otherwise, the sensor 115 is similar to the sensor 110; and a description is omitted. The second elastic unit 42 is deformable. By using the second elastic unit 42, for example, the failure of at least one of the structure body 10 or the first flexible unit 21 is suppressed.

FIG. 7 is a schematic cross-sectional view illustrating another sensor according to the first embodiment.

As shown in FIG. 7, the sensor 116 according to the embodiment further includes a damper 43 in addition to the structure body 10, the first flexible unit 21, the first sensing unit 31., and the supporter 40. The damper 43 is connected to the supporter 40 and the second portion 12. Otherwise, the sensor 116 is similar to the sensor 110; and a description is omitted. The damper 43 is deformable. For example, the damper 43 absorbs shocks applied to the second portion 12. For example, the damper 43 absorbs shocks applied to the first flexible unit 21. By using the damper 43, for example, the failure of at least one of the structure body 10 or the first flexible unit 21 is suppressed.

The damper 43 includes, for example, PDMS, synthetic rubber, natural rubber, or a silicone oil (an oil damper). The second elastic unit 42 and the damper 43 may be provided in the embodiment.

FIG. 8 is a schematic cross-sectional view illustrating another sensor according to the first embodiment.

In the sensor 117 according to the embodiment as shown in FIG. 8, the configuration of the first sensing unit 31 is different from the configuration of the first sensing unit 31 of the sensor 110. Otherwise, the sensor 117 is similar to the sensor 110.

As shown in FIG. 8, the first sensing unit 31 includes the first electrode 31e and the second electrode 31f. The first electrode 31e is provided on at least a portion of the first flexible unit 21. The first flexible unit 21 has a surface opposing the supporter 40. For example, the first electrode 31e is provided on the surface of the first flexible unit 21. The second electrode 31f is separated from the first electrode 31e. The second electrode 311 opposes the first electrode 31e. The supporter 40 has a surface opposing the first flexible unit 21. The second electrode 31f is provided on the surface of the supporter 40. The distance between the first electrode 31e and the second electrode 31f changes according to the deformation of the first flexible unit 21. The electrostatic capacitance between the first electrode 31e and the second electrode 31f changes according to the deformation of the first flexible unit 21. In the example, the first sensing unit 31 is an electrostatic-capacitance type. High sensitivity is obtained in the sensor 117 as well.

### Second Embodiment

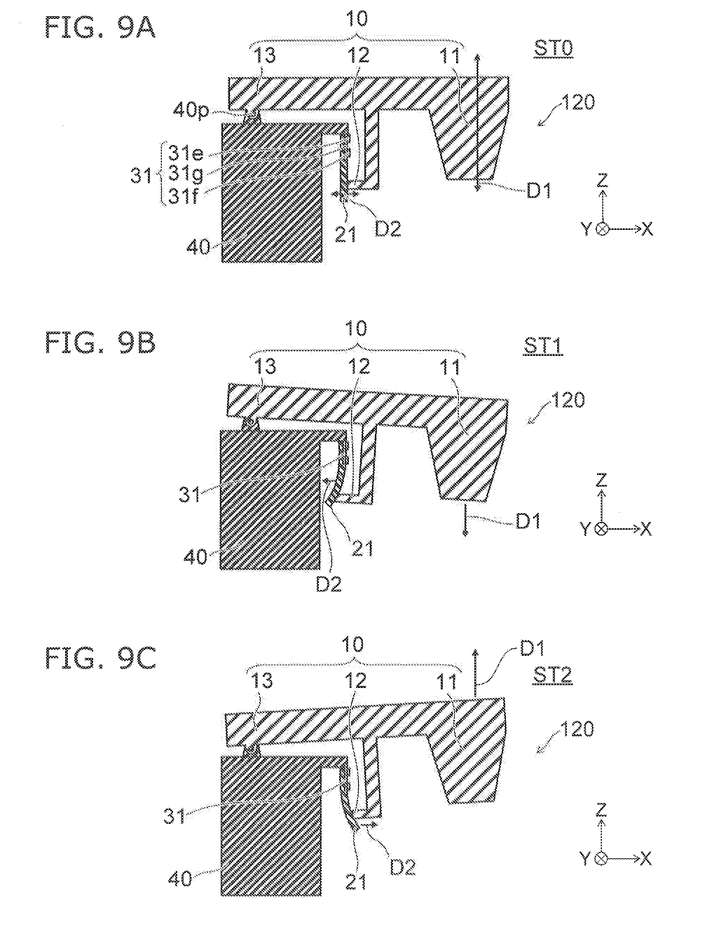

FIG. 9A to FIG. 9C are schematic cross-sectional views illustrating another sensor according to a second embodiment.

FIG. 9A illustrates one state ST0 (e.g., the initial state). FIG. 9B illustrates the first state ST1. FIG. 9C illustrates the second state ST2.

As shown in FIG. 9A, the sensor 120 according to the embodiment includes the structure body 10, the first flexible unit 21, the first sensing unit 31, and the supporter 40.

The structure body 10 includes the first portion 11, the second portion 12, and the third portion 13. The second portion 12 is linked to the first portion 11. In the example, the second portion 12 is provided between the first portion 11 and the third portion 13.

In such a case as well, as shown in FIG. 9B and FIG. 9C, the first portion 11 is displaced along the first direction D1. The first direction D1 is taken as the Z-axis direction. In such a case as well, the first direction D1 intersects the direction connecting the first portion 11 and the second portion 12. In the state ST0 shown in FIG. 9A, the direction connecting the first portion 11 and the second portion 12 is aligned with the X-axis direction.

As shown in FIG. 9B and FIG. 9C, the second portion 12 is displaced along the second direction D2 according to the displacement of the first portion 11. The second direction D2 intersects the first direction D1.

The supporter 40 supports the third portion 13. For example, the pin 40p is provided to pierce the third portion 13 and a portion of the supporter 40. The structure body 10 is rotatable with the pin 40p as the center. The first portion 11 is displaced along the first direction D1 according to the rotation. The structure body 10 is, for example, a lever. The pin 40p corresponds to a fulcrum.

The second portion 12 is displaced along the second direction D2 according to the displacement of the first portion 11. In other words, due to the rotation of the structure body 10 recited above, the first portion 11 is displaced along the first direction D1; and the second portion 12 is displaced along the second direction D2 in conjunction with the displacement of the first portion 11. In the sensor 120 as well, even in the case where the acceleration that is applied to the first portion 11 along the first direction D1 is applied to the first flexible unit 21, the effects of the acceleration on the first flexible unit 21 can be suppressed. Thereby, the sensitivity can be increased.

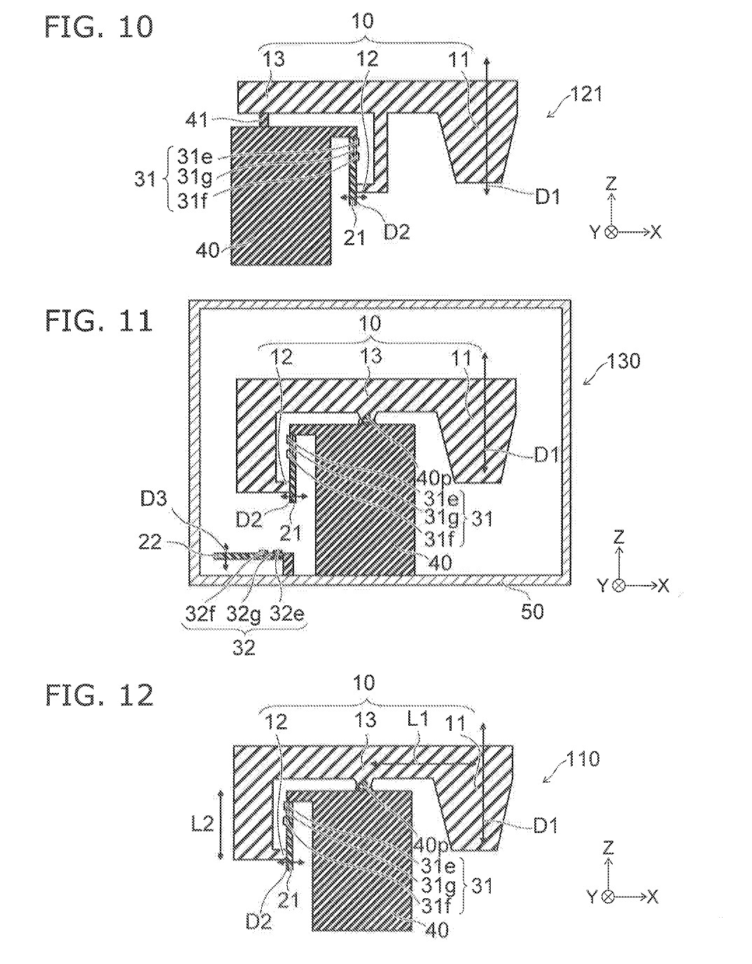

FIG. 10 is a schematic cross-sectional view illustrating another sensor according to the second embodiment.

As shown in FIG. 10, the sensor 121 according to the embodiment further includes the first elastic unit 41 in addition to the structure body 10, the first flexible unit 21, the first sensing unit 31, and the supporter 40. The first elastic unit 41 is, for example, a parallel spring (referring to FIG. 4B). The first elastic unit 41 may be an elastic hinge (referring to FIG. 5B).

Thus, the supporter 40 and the first elastic unit 41 are provided in the sensor 121. The second portion 12 of the structure body 10 is provided between the first portion 11 and the third portion 13. The first elastic unit 41 is provided between the supporter 40 and the third portion 13. The supporter 40 supports the third portion 13 via the first elastic unit 41.

The intermediate layer 25 (referring to FIG. 3) may be further provided in the sensors 120 and 121. The linking unit 26 (referring to FIG. 3) may be further provided. The second elastic unit 42 (referring to FIG. 6) may be further provided. The damper 43 (referring to FIG. 7) may be further provided. In the sensors 120 and 121, the first sensing unit 31 may be an electrostatic-capacitance type (referring to FIG. 8).

### Third Embodiment

FIG. 11 is a schematic cross-sectional view illustrating another sensor according to a third embodiment.

As shown in FIG. 11, the sensor 130 according to the embodiment includes a second flexible unit 22 and a second sensing unit 32 in addition to the structure body 10, the first flexible unit 21, the first sensing unit 31, and the supporter 40. The structure body 10, the first flexible unit 21, the first sensing unit 31, and the supporter 40 are similar to those of the sensor 110; and a description is therefore omitted.

A housing 50 is provided in the example. The supporter 40 is fixed to the housing 50. The second flexible unit 22 is fixed to the housing 50. The second flexible unit 22 is separated from the housing 50.

The second flexible unit 22 deforms along a third direction D3. The third direction D3 intersects the second direction D2. In the example, the third direction D3 has a component in the first direction D1. For example, the third direction D3 is aligned with the first direction D1.

The second sensing unit 32 senses the deformation along the third direction D3 of the second flexible unit 22.

In the example, the second sensing unit 32 includes a second element unit 32g, a third electrode 32e, and a fourth electrode 32f. Stress is applied to the second element unit 32g according to the deformation of the second flexible unit 22. The second element unit 32g deforms according to the deformation of the second flexible unit 22. The second element unit 32g is, for example, a silicon thin film. The second element unit 32g may be continuous with the second flexible unit 22. The third electrode 32e is connected to the second element unit 32g. The fourth electrode 32f is connected to the second element unit 32g and is separated from the third electrode 32e.

The electrical characteristic (e.g., the electrical resistance) between the third electrode 32e and the fourth electrode 32f changes according to the deformation of the second flexible unit 22. In the case where, for example, a piezoelectric body is used as the second element unit 32g, when the second element unit 32g deforms according to the deformation of the second flexible unit 22, the potential difference that is generated in the second element unit 32g (the potential difference between the third electrode 32e and the fourth electrode 32f) changes. The second sensing unit 32 may sense an electrostatic capacitance according to the deformation along the third direction D3 of the second flexible unit 22. In such a case, as described in reference to the sensor 117, the third electrode 32e is provided on at least a portion of the second flexible unit 22. The fourth electrode 32f is separated from the third electrode 32e. The fourth electrode 32f opposes the third electrode 32e. The distance between the third electrode 32e and the fourth electrode 32f changes according to the deformation of the second flexible unit 22. The electrostatic capacitance between the third electrode 32e and the fourth electrode 32f changes according to the deformation of the second flexible unit 22. In the embodiment, the method (and structure) for sensing the deformation of the second flexible unit 22 is arbitrary.

The second flexible unit 22 is not connected to the structure body 10. Compared to the first portion of the structure body 10, the second flexible unit 22 moves easily. For example, the mass of the second flexible unit 22 is smaller than the mass of the first portion 11 of the structure body 10. For example, the mass of the second flexible unit 22 is not less than 10⁻⁶ times but less than 1 times the mass of the first portion 11 of the structure body 10.

For example, the second flexible unit 22 and the second sensing unit 32 sense a high frequency acceleration. For example, the peak sensitivity frequency of the acceleration sensed by the second sensing unit 32 is higher than the peak sensitivity frequency of the acceleration sensed by the first sensing unit 31. The peak sensitivity frequency of the displacement sensed by the second sensing unit 32 is higher than the peak sensitivity frequency of the displacement sensed by the first sensing unit 31. The peak sensitivity frequency of the acceleration sensed by the second sensing unit 32 is not less than 10 Hz and not more than 10 MHz. The peak sensitivity frequency of the displacement sensed by the second sensing unit 32 is not less than 10 Hz and not more than 10 MHz.

In the sensor 130, the acceleration of the low frequency is sensed by the first flexible unit 21 and the first sensing unit 31; and the acceleration of the high frequency is sensed by the second flexible unit 22 and the second sensing unit 32. The sensor 130 is convenient. Applications of the sensor are increased.

In the embodiment, as described in the second embodiment, the second portion 12 of the structure body 10 may be provided between the first portion 11 and the third portion 13. The supporter 40 may support such a third portion 13. The intermediate layer 25 (referring to FIG. 3) may be further provided in the embodiment. The linking unit 26 (referring to FIG. 3) may be further provided. The second elastic unit 42 (referring to FIG. 6) may be further provided. The damper 43 (referring to FIG. 7) may be further provided.

The sensors according to the first and second embodiments recited above are, for example, low frequency vibration sensors. Each sensor includes, for example, a weight that receives inertial force due to vibrations, a lever that is connected to the weight, a fulcrum that supports the lever, a flexible unit that is connected to the weight via the lever, and a sensing unit that is provided at a portion of the flexible unit. The sensing unit senses the displacement of the flexible unit deforming due to the inertial force of the weight. For example, the flexible unit may be mounted in a direction perpendicular to the direction of gravity. For example, the flexible unit is mounted in a direction perpendicular to the acceleration sensing direction.

The MEMS sensor is advantageous for compactness, reducing the price, etc. The MEMS sensor may be advantageous as a replacement for a piezoelectric sensor in some applications. Applications are possible not only as a pressure sensor and an acoustic region (microphone) sensor but also as a sensor for the ultrasound region. For example, an acceleration sensor using a MEMS is formed by a semiconductor process. Therefore, compared to other sensors (e.g., a piezoelectric sensor, etc.), it is considered that the cost can be reduced. In the MEMS acceleration sensor, the flexible body such as a cantilever, a diaphragm, or the like is formed by, for example, a silicon process. The sensing element is disposed at the portion where a large strain of the flexible body occurs. The strain that is applied to the sensing element is converted into a voltage. The acceleration is sensed by sensing the voltage.

The sensing of the acceleration utilizes the deformation of the flexible body due to the mass (the weight) of the flexible body. At frequencies in the low frequency range (about 0.1 Hz to 10 Hz) in such a sensor, the acceleration that is applied to the flexible body is small; the deformation is small; and the sensing is difficult.

In the embodiment, the flex of the flexible unit due to its own weight is improved and is small. A structure is employed in which the load is applied directly to the flexible unit. The load that is applied may be applied using an interposed member, i.e., a flexible medium such as PDMS or the like, a liquid, etc. A lever is utilized as a unit for applying the load. The sensor is disposed in a direction orthogonal to the displacement direction of the weight (the direction of its own weight).

The load due to the weight's own weight is applied to a cantilever via a lever. Therefore, in the low frequency range as well, sufficient deformation of the flexible unit can be obtained. By applying the load in the orthogonal direction, the effects of the cantilever's own weight can be suppressed. Also, the effects of the weight of the interposed member recited above can be suppressed. It is possible to apply only the load of the weight unit. The sensor design is easy.

FIG. 12 is a schematic cross-sectional view illustrating the sensor according to the embodiment.

In FIG. 12, a first mass M1 (units: kg) is the mass of the first portion 11. A rigidity Kf (units: N/m) is the flexural rigidity of the first flexible unit 21 in the second direction D2. A first distance L1 (units: m) is the distance along the second direction D2 between the pin 40p and the center of gravity of the first portion 11. A second distance L2 (units: m) is the distance along the first direction D1 between the pin 40p and the first flexible unit 21. An angle θ (units: rad) is the rotational displacement of the pin 40p.

The case where the angle θ is small is as follows. The displacement along the first direction D1 of the first portion 11 is L1·(sin θ), and is substantially L1·θ. The displacement along the second direction D2 of the first flexible unit 21 is L2·(sin θ), and is substantially L2·θ. The following first formula is derived from the balance of the moment around the pin 40p.

M1·L1·<θ2>=Kf·L2·θ (1)

In the first formula, <θ2> is the second derivative of θ.

The first formula recited above is an equation of simple harmonic motion for a micro angle θ. The natural frequency (the frequency) is (½π)·((Kf·L2)/(M1·L1))^{1/2}.

For example, in the case where the first distance L1 is the same as the second distance L2, the first mass M1 is 10 times the rigidity Kf. Although the system of units of the mass and the rigidity are different, here, the values are simply compared. In such a case, the natural frequency is (½π)/(10^{1/2}) and is about 0.32 times that of the case where the first mass M1 is equal to the rigidity Kf. In the region of the natural frequency or less, the value of the displacement occurring when the same acceleration input acts increases as the natural frequency decreases. Thereby, the sensitivity at low frequency is higher.

For example, Mf is the mass of the first flexible unit 21. The value of the rigidity Kf of the first flexible unit 21 is taken to be about the same as the mass Mf of the first flexible unit 21 (although the system of units are different, the values are simply compared). In such a case, the mass of the first portion 11 is not less than 10 times the mass of the first flexible unit 21. The value of the mass Mf of the first flexible unit 21, the value of the rigidity Kf of the first flexible unit 21, and the value of the first mass M1 of the first portion 11 are set to appropriate values. Thereby, the frequencies of high sensitivity can be designed.

In the embodiment, the peak sensitivity frequency is, for example, 10 Hz or less. For example, the first distance L1 is the same as the second distance L2. For example, the first mass M1 (units: kg) is not less than about 2.53×10⁻⁴ times the rigidity Kf (units: N/m).

In the embodiment, the peak sensitivity frequency is, for example, 0.1 Hz or more. For example, the first distance L1 is the same as the second distance L2. The first mass M1 (units: kg) is not more than about 2.53 times the rigidity Kf (units: N/m). The peak sensitivity frequency of the acceleration or the displacement sensed by the first sensing unit 31 is not less than 0.1 Hz and not more than 10 Hz.

According to the embodiments, a sensor in which the sensitivity can be increased is provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as structure bodies, flexible units, sensing units, electrodes, element units, supporters, elastic units, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors practicable by an appropriate design modification by one skilled in the art based on the sensors described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed:

1. A sensor, comprising:
a structure body including a first portion and a second portion, the second portion being linked to the first portion, the first portion being displaced along a first direction intersecting a direction connecting the first portion and the second portion, the second portion being displaced along a second direction according to the displacement of the first portion, the second direction intersecting the first direction;
a first flexible unit deforming along the second direction according to the displacement of the second portion along the second direction; and
a first sensing unit sensing the deformation of the first flexible unit.

2. The sensor according to claim 1, wherein a mass of the first portion is larger than a mass of the first flexible unit.

3. The sensor according to claim 1, further comprising a supporter,
the structure body further including a third portion between the first portion and the second portion,
the supporter supporting the third portion.

4. The sensor according to claim 1, further comprising a supporter,
the structure body further including a third portion,
the second portion being provided between the first portion and the third portion,
the supporter supporting the third portion.

5. The sensor according to claim 1, further comprising:
a supporter; and
a first elastic unit,
the structure body further including a third portion between the first portion and the second portion,
the first elastic unit being provided between the supporter and the third portion,
the supporter supporting the third portion via the first elastic unit.

6. The sensor according to claim 1, further comprising:
a supporter; and
a first elastic unit,
the structure body further including a third portion,
the second portion being provided between the first portion and the third portion,
the first elastic unit being provided between the supporter and the third portion,
the supporter supporting the third portion via the first elastic unit.

7. The sensor according to claim 3, further comprising a second elastic unit connected to the supporter and the second portion.

8. The sensor according to claim 3, further comprising a damper connected to the supporter and the second portion.

9. The sensor according to claim 1, further comprising an intermediate layer provided between the second portion and the first flexible unit,
a Young's modulus of the intermediate layer being lower than a Young's modulus of the first flexible unit.

10. The sensor according to claim 1, wherein
the first sensing unit includes:
a first element unit deforming according to the deformation of the first flexible unit;
a first electrode connected to the first element unit; and
a second electrode connected to the first element unit and separated from the first electrode,
an electrical characteristic between the first electrode and the second electrode changing according to the deformation of the first flexible unit.

11. The sensor according to claim 1, wherein
the first sensing unit includes:
a first electrode provided on at least a portion of the first flexible unit; and
a second electrode separated from the first electrode,
an electrostatic capacitance between the first electrode and the second electrode changing according to the deformation of the first flexible unit.

12. The sensor according to claim 1, wherein a peak sensitivity frequency of a displacement sensed by the first sensing unit is not less than 0.1 Hz and not more than 10 Hz.

13. The sensor according to claim 2, further comprising:
a second flexible unit deforming along a third direction intersecting the second direction; and
a second sensing unit sensing the deformation along the third direction of the second flexible unit,
a mass of the second flexible unit being smaller than the mass of the first portion.

14. The sensor according to claim 13, wherein the third direction has a component in the first direction.

15. The sensor according to claim 1, wherein a mass of the first portion is not less than 10 times a mass of the first flexible unit.

16. The sensor according to claim 14, wherein a mass of the first portion is not more than 100 times a mass of the first flexible unit.

17. The sensor according to claim 1, wherein a length along the second direction of the first flexible unit is not less than 0.01 micrometers and not more than 1000 micrometers.

18. The sensor according to claim 16, wherein the first flexible unit includes silicon.

19. The sensor according to claim 1, wherein a peak sensitivity frequency of an acceleration sensed by the first sensing unit is not less than 0.1 Hz and not more than 10 Hz.

20. The sensor according to claim 1, further comprising an intermediate layer provided between the second portion and the first flexible unit,
the intermediate layer including a liquid.
